(19) United States
(12) Patent Application Publication
(10) Pub. No.: US 2011/0161531 A1
(43) Pub. Date: Jun. 30, 2011

(54) USB DEVICE APPARATUS

(75) Inventor: Toshihiko Katayama, Higashichikuma-gun (JP)

(73) Assignee: SEIKO EPSON CORPORATION, Shinjuku-ku (JP)

(21) Appl. No.: 12/978,262

(22) Filed: Dec. 23, 2010

(30) Foreign Application Priority Data
Dec. 25, 2009 (JP) 2009-294242

(51) Int. Cl. G06F 3/00

(52) U.S. Cl. 710/14

(57) ABSTRACT

A USB device apparatus, which is capable of performing communication with a USB host apparatus through a USB connection supporting a high-speed USB mode, includes a communication section configured to be capable of performing communication with the USB host apparatus, and a connection section configured to, while the USB device apparatus is being connected to the USB host apparatus by the communication section through a USB connection in the high-speed USB mode, when a predetermined condition for movement to a sleep status is satisfied, perform switching of a connection mode of the USB connection to the USB apparatus from the high-speed USB mode to a full-speed USB mode.

### BACKGROUND

1. Technical Field

The present invention relates to USB device apparatuses each being capable of performing communication with a USB host apparatus through a USB connection supporting the high-speed USB mode.

2. Related Art

To date, among this kind of USB device apparatuses, USB device apparatuses each supporting the high-speed USB mode conforming to the USB specification have been proposed (for example, refer to JP-A-2004-310174). Such a USB device apparatus supporting the high-speed USB mode is configured to operate being supplied with electric power charged in batteries thereof functioning as an electric power supply, and while performing communication at a communication rate for the high-speed USB mode, upon detection of the shortage of a remaining amount of electric power charged in the batteries thereof, the USB device apparatus attempts to maintain an operational period of time thereof as long as possible by issuing a reset signal to perform switching from the high-speed USB mode to the full-speed USB mode.

As shown above, in the high-speed USB mode, although a data connection rate for the high-speed USB mode is higher than a data connection rate for the full-speed USB mode, an electric current of approximately 18 mA constantly continues to flow through a USB connection, and thus, the high-speed USB mode is not appropriate to realization of reduction of electric power consumption. In general, for electronic devices, nowadays, realization of reduction of electric power consumption, as well as realization of high performance, has been increasingly demanded, and thus, for the USB device apparatuses as well, realization of reduction of electric power consumption, as well as realization of high-speed data connection rates, has been demanded.

### SUMMARY

An advantage of some aspects of the invention is to provide a USB device apparatus which enables realization of reduction of electric power consumption.

Hereinafter, a USB device apparatus according to some aspects of the invention will be described.

A USB device apparatus according to a first aspect of the invention, which is capable of performing communication with a USB host apparatus through a USB connection supporting a high-speed USB mode, includes a communication section configured to be capable of performing communication with the USB host apparatus, and a connection section configured to, while the USB device apparatus is being connected to the USB host apparatus by the communication section through a USB connection in the high-speed USB mode, when a predetermined condition for movement to a sleep status is satisfied, perform switching of a connection mode of the USB connection to the USB apparatus from the high-speed USB mode to a full-speed USB mode.

The USB device apparatus according to the first aspect is configured to, while the USB device apparatus is being connected to the USB host apparatus through a USB connection in the high-speed USB mode, when any one of predetermined conditions for movement to a sleep status is satisfied, perform switching of a connection mode of the USB connection to the USB host apparatus from the high-speed USB mode to a full-speed USB mode. Therefore, the USB device apparatus according to the first aspect enables movement to the sleep status being connected through a USB connection in the full-speed USB mode, and thus, it is possible to realize reduction of electric power consumption. Here, the “predetermined conditions” include a condition which is satisfied when a status in which no manual operation relating to the USB device apparatus is performed has been continued for more than or equal to a predetermined period of time, a condition which is satisfied when a status in which no command from the USB host apparatus is received has been continued for more than or equal to a predetermined period of time, and the like.

Further, in the USB device apparatus according to the first aspect, the connection section can be configured to, while the USB device apparatus is being connected to the USB host apparatus through a USB connection in the full-speed USB mode, when an amount of communication data exceeds a predetermined amount, disconnect the USB connection in the full-speed USB mode, and further, reconnect the USB device apparatus to the USB host apparatus through the USB connection in the high-speed USB mode. Such a way as described above enables realization of reduction of electric power consumption, as well as realization of high-speed data connection rates. Further, in the USB device apparatus according to the first aspect, the connection section can be configured to, while the USB device apparatus is being connected to the USB host apparatus through a USB connection in the full-speed USB mode, when a request for acquisition of status information has been received from the USB host apparatus, maintain the full-speed USB mode as it is, and when a request for execution of a job has been received from the USB host apparatus, disconnect the USB connection in the full-speed USB mode, and further, reconnect the USB device apparatus to the USB host apparatus through the USB connection in the high-speed USB mode. Further, the USB device apparatus according to the first aspect can be configured to function as a printing apparatus that is configured to, when, as the request from the USB host apparatus for execution of a job, receive a request for execution of a printing job, and execute the printing job. Further, the USB device apparatus according to the first aspect can be configured to function as a scanner apparatus that is configured to, when, as the request from the USB host apparatus for execution of a job, receive a request for execution of a scanning job, and execute the scanning job.

A USB device apparatus according to a second aspect of the invention, which is capable of performing communication with a USB host apparatus through a USB connection supporting a high-speed USB mode, includes a communication section configured to be capable of performing communication with the USB host apparatus, and a connection section configured to, while the USB device apparatus is being connected to the USB host apparatus by the communication section through a USB connection in the high-speed USB mode or in a full-speed USB mode, when a predetermined condition for movement to a sleep status is satisfied, perform switching of a connection status of the USB connection to the USB host apparatus to a suspend status.

The USB device apparatus according to the second aspect is configured to, while the USB device apparatus being connected to the USB host apparatus through a USB connection in the high-speed USB mode or in the full-speed USB mode, when any one of predetermined conditions for movement to a sleep status is satisfied, perform switching of a connection status of the USB connection to the USB host apparatus to a suspend status. Owing to this operation, the USB device apparatus according to the second aspect enables the USB connection to be in the full-speed USB mode under an idle status, and thus, it is possible to realize reduction of electric power consumption. Here, the “predetermined conditions” include a condition which is satisfied when a status in which no manual operation relating to the USB device apparatus is performed has been continued for more than or equal to a predetermined period of time, a condition which is satisfied when a status in which no command from the USB host apparatus is received has been continued for more than or equal to a predetermined period of time, and the like.

In the USB device apparatus according to the second aspect, the connection section can be configured to, while the USB device apparatus is being connected to the USB host apparatus through a USB connection in the suspend status, when communication data has been generated, resume from the suspend status, further, when an amount of the communication data exceeds a predetermined amount, reconnect the USB device apparatus to the USB host apparatus through the USB connection in the high-speed USB mode, and when the amount of the communication data does not exceed the predetermined amount, reconnect the USB device apparatus to the USB host apparatus through the USB connection in the full-speed USB mode. Further, the above-described connection section can be configured to, while the USB device apparatus is being connected to the USB host apparatus through a USB connection in the suspend status, when a communication command has been received from the USB host apparatus, resume from the suspend status, and reconnect the USB device apparatus to the USB host apparatus through the USB connection in the high-speed USB mode or the full-speed USB mode, whichever is determined in accordance with a content of the communication command. Such a way as described above enables realization of reduction of electric power consumption, as well as realization of high-speed data connection rates. In the latter case, the communication command can be either of three kinds of communication commands, a first one being a communication command that specifies the high-speed USB mode or the full-speed USB mode, with which the reconnection is to be performed by the connection section, a second one being a communication command that specifies an amount of data for communication with the USB host apparatus, which is to be performed immediately subsequent to receipt of the communication command, a third one being a communication command that specifies a kind of data for communication with the USB host apparatus, which is to be performed immediately subsequent to receipt of the communication command. Further, in the USB device apparatus according to the second aspect, the connection section can be configured to, while the USB device apparatus is being connected to the USB host apparatus through a USB connection in the suspend status, when communication data has been generated, resume from the suspend status, and reconnect the USB device apparatus to the USB host apparatus through the USB connection in the high-speed USB mode or the full-speed USB mode, whichever is determined in accordance with a kind of the communication data.

### BRIEF DESCRIPTION OF THE DRAWINGS

The invention will be described with reference to the accompanying drawings, wherein like numbers reference like elements.

FIG. 1 is a diagram illustrating an outline of a configuration of a printing system according to an embodiment of the invention.

FIG. 2 is a flowchart illustrating an example of user-PC-side processing according to an embodiment of the invention.

FIG. 3 is a flowchart illustrating an example of printer-side processing according to an embodiment of the invention.

### DESCRIPTION OF EXEMPLARY EMBODIMENTS

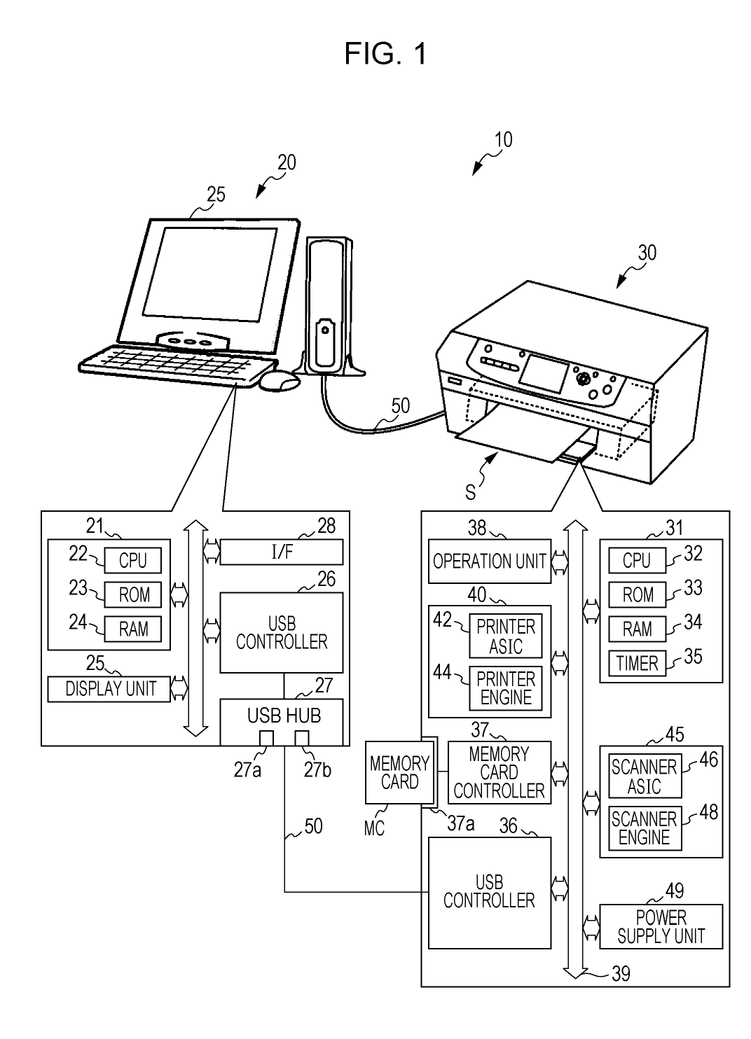

Next, an embodiment according to the invention will be described with reference to drawings. FIG. 1 is a diagram illustrating an outline of a configuration of a printing system 10 according to an embodiment of the invention. As shown in FIG. 1, the printing system 10 is configured to include a user computer (hereinafter, which will be called a user PC) 20 functioning as a USB host, and a multi-function printer 30 functioning as a USB device, the user PC 20 and the multi-function printer 30 being connected to each other via a USB cable 50.

The multi-function printer 30 is configured to include: a main controller configured to perform control of the whole of the apparatus; a printer unit 40 configured to perform printing by discharging ink, which functions as a coloring material, onto a recording sheet of paper S; a scanner unit 45 configured to create image data on the basis of signals obtained by optically reading therein the content of a document that is positioned on a document plane; a USB controller 36 configured to performs control of data transfer to/from the user PC 20 via the USB cable 50 in accordance with the USB specification 2.0; a memory card controller 37 configured to perform processing for outputting and inputting of data to/from a memory card MC, which is inserted into a memory card slot 37a; an operation unit 38 configured to include a power button, a mode selection button for selecting any one of operation modes, a start button and the like; and a power supply unit 49 configured to supply individual portions of the apparatus with electric power fed from a commercial electric power source, these above-described components being connected to one another via a bus 39. In addition, the operation modes, any one of which can be selected by using the mode selection button, are such as a scanning mode, in which the content of a document positioned on a document plane is read in, a copy mode, in which the content of a document positioned on a document plane is read in and is printed, and a memory card mode, in which image data stored in the memory card MC is read out and is printed.

The printer unit 40 is configured to include a printer ASIC 42 and a printer engine 44. The printer ASIC 42 is an integrated circuit configured to perform control of the printer engine 44. Further, upon receipt of a print command from the main controller 31, the printer ASIC 42 performs control so as to cause the printer engine 44 to perform printing on a sheet of paper on the basis of an image file targeted for printing, which is specified by the print command. The printer engine 44 is configured as a color printer mechanism employing a well-known ink jet printing method, in which printing is performed by discharging ink from a print head thereof onto a sheet of paper. In addition, the ASIC is an abbreviation of Application Specific Integrated Circuit.

The scanner unit 45 is configured to include a scanner ASIC 46 and a scanner engine 48. The scanner ASIC 46 is an integrated circuit configured to perform control of the scanner engine 48. Further, upon receipt of a scan command from the main controller 31, the scanner ASIC 46 performs control so as to cause the scanner engine 48 to read thereinto the content of a document positioned on a document plane as image data. Further, the scanner engine 48 is configured as a well-known image scanner, and includes a well-known color image sensor configured to separate and convert reflected light rays, which result from emission of light rays towards a document positioned on a document plane, into scan data including three primary light components, i.e., a red (R) light component, a green (G) light component and a blue (B) light component.

The memory card controller 37 is configured to, by transmitting and receiving data to/from the memory card MC, which is inserted into the memory card slot 37a, read out files of data stored in the memory card MC to transmit the read-out files of data to the main controller 31, and write data into the memory card MC in accordance with a command from the main controller 31.

The USB controller 36 is a controller conforming to the USB specification 2.0 and supporting the high-speed mode data transfer and the full-speed mode data transfer. A USB is configured to include two power-supply system lines consisting of a VBUS line and a GND line, and two signal system lines consisting of a D+ line and a D− line, and allows supply of electric power of +5 V trough the power-supply system lines and transmission and reception of data through the signal system lines.

The main controller 31 is configured as a micro processor that is centered on a CPU 32, and includes a ROM 33 configured to store various kinds of processing programs therein, a RAM 34 configured to temporarily store data therein, and a timer 35. The RAM 34 include a receiving buffer configured to store therein commands and requests having been received from the user PC 20 (for example, a command for execution of a job, such as a printing job and a scanning job, and a request for acquisition of status information, such as operation information relating to the operation unit 38 (a start button and the like), a remaining amount of ink in an ink cartridge, and error information).

The multi-function printer 30 according to this embodiment has a sleep mode, which allows halting supply of electric power to individual portions thereof, such as a motor and a scanner, which are included in the printer unit 40 and the scanner unit 45, respectively, and thereby, enables realization of reduction of electric power consumption. In this embodiment, in the case where any one of conditions for movement to the sleep mode, such as a condition in which, a status in which no manual operation relating to the multi-function printer 30 (the operation unit 38) is performed has been continued for more than or equal to a predetermined period of time, and a condition in which, a status in which no command from the user PC 20 is received has been continued for more than or equal to a predetermined period of time, is satisfied, an operation mode of the multi-function printer 30 moves to the sleep mode. Further, any one of conditions for release from the sleep mode, such as a condition in which any manual operation relating to the operation unit 38 has been performed, and a condition in which any command from the user PC 20 has been received, is satisfied, the operation mode of the multi-function printer 30 is resumed from the sleep mode.

The user PC 20 is a general-purpose computer configured to include a display unit 25, such as a liquid crystal display, a USB controller 26, a USB hub 27, which is connected to the USB controller 26, and an interface (I/F) 28. Further, the user PC 20 transmits and receives various commands and responses to/from the multi-function printer 30 in accordance with a program (a printer driver) having been installed in a HDD, which is omitted from illustration. The USB controller 26 is a controller conforming to the USB specification 2.0, and supporting the high-speed mode data transfer and the full-speed mode data transfer. The USB hub 27 is configured to include a plurality of ports 27a and 27b, one of which is connected to the multi-function printer 30 via the USB cable 50.

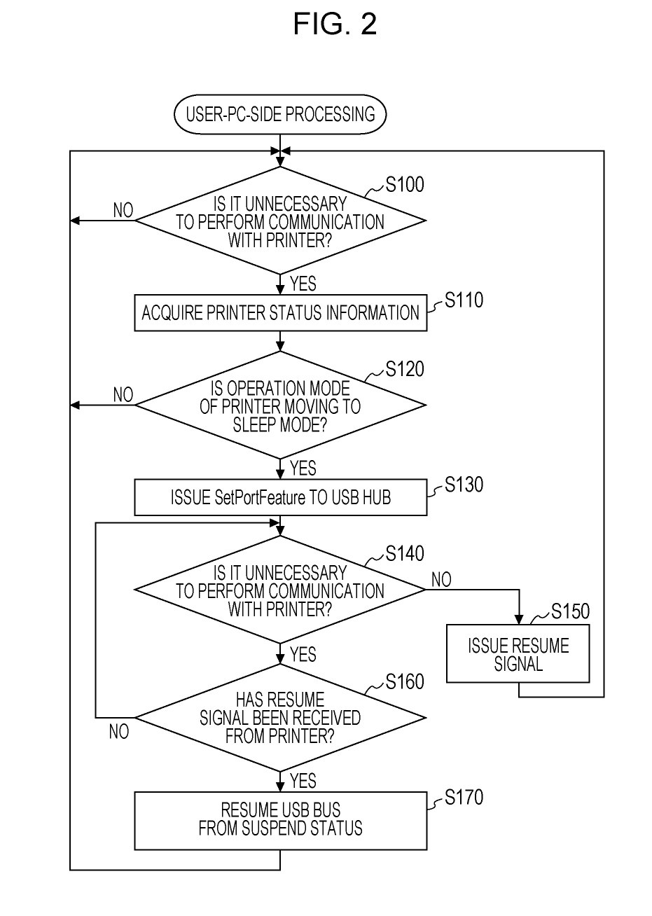

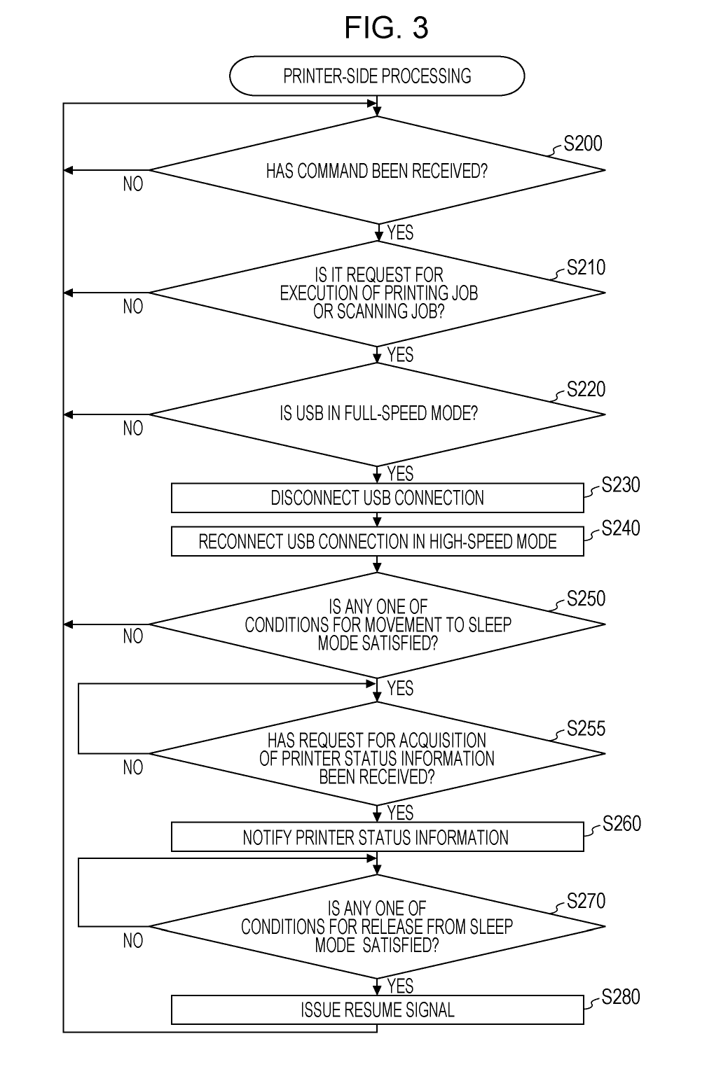

Next, processing performed by the printing system 10 according to this embodiment, which is configured in such a way as described above, will be described below, particularly focusing on processing performed when an operation mode of the multi-function printer 30 moves to a sleep mode. Firstly, processing performed at the user PC 20 side will be described, and subsequently thereto, processing performed at the multi-function printer 30 side will be described. FIG. 2 is a flowchart illustrating an example of user-PC-side processing according to this embodiment, and FIG. 3 is a flowchart illustrating an example of printer-side processing according to this embodiment.

In user-PC-side processing, the CPU 22 of the controller 21 performs communication with the multi-function printer 30, for example, in the case where, in accordance with necessity, the CPU 22 issues a command or makes a request to the multi-function printer 30, and once it becomes unnecessary for the CPU 22 to perform communication with the multi-function printer 30 (step S100), the CPU 22 acquires printer status information from the multi-function printer 30 (step S110). If the acquired printer status information indicates that an operation status of the multi-function printer 30 is moving to a sleep mode (step S120), the CPU 22 issues a command “SetPortFeature (PORT SUSPEND)”, which is a request for causing the USB connection to the multi-function printer 30 functioning as a USB device to be in a suspend status, to the USB hub 27 (step S130). In order that, out of the plurality of ports 27a and 27b included in the USB hub 27, only the target port 27b, which is connected to the multi-function printer 30, can be selectively suspended, the command “SetPortFeature (PORT_SUSPEND) is issued with settings of a port number in an index field thereof and a command message “PORT_SUSPEND” in a value field thereof. Owing to such processing, the USB hub 27 does not transmit any traffic to the target port 27b, and as a result, the target port 27b is in the suspend status. At this time, even if a connection mode of the USB connection has been the high-speed USB mode, the connection mode is switched to the full-speed USB mode, and thus, an amount of electric power consumption in the suspend status becomes relatively small. Further, the CPU 22 of the controller 21 determines whether it is unnecessary to perform communication with the multi-function printer 30, or not (step S140), and once it is determined that it is necessary to perform communication with the multi-function printer 30, the user PC 20, which is a host, issues a resume signal to change the USB bus status from an idle status, and thereby, causes the USB connection to be in a resume status (step S150), and then, causes the process flow to return to step S100. In contrast, when it is determined that it is unnecessary to perform communication with the multi-function printer 30, the CPU 22 of the controller 21 waits for receipt of a resume signal from the multi-function printer 30 (step S160), and upon receipt of the resume signal, the CPU 22 causes the USB connection to resume from the suspend status (i.e., the CPU 22 causes the USB connection to be in a resume status) (step S170), and then, causes the process flow to return to step S100.

In printer-side processing, the CPU 32 of the main controller 31 waits until receipt of a command from the user PC 20 (step S200), and upon receipt of the command from the user PC 20, the CPU 32 determines whether the received command is related to a printing job or a scanning job (step S210), for which high-speed data transmission and reception is necessary, and further, determines whether a current connection mode is the full-speed USB mode, or not (step S220). If it is determined that the current connection mode is the full-speed USB mode and the command from the user PC 20 is a command related to a request for acquisition of status information, such as a remaining amount of ink or error information, for which high-speed data transmission and reception is unnecessary, or the current connection mode is the high-speed USB mode, the CPU 32 maintains the current connection mode as it is, and then, causes the process flow to return to step S200. If it is determined that the current connection mode is the full-speed USB mode, and further, the command from the user PC 20 is related to a printing job or a scanning job, the CPU 32 resets the USB port by disconnecting the USB connection to the user PC 20 (step S230), and performs a reconnection to the user PC 20 through a USB connection in the high-speed USB mode (step S240). Here, the reconnection through a USB connection in the high-speed USB mode is performed so that, by pulling up the D+ line, the multi-function printer 30 notifies the user PC 20 of that the multi-function printer 30 itself is a USB device supporting the full-speed USB mode; upon receipt of this notification, the user PC 20 issues a USB bus reset signal to the multi-function printer 30; during execution of the USB bus reset signal, the multi-function printer 30 issues a chirp-K signal; upon receipt of the chirp-K signal, the user PC 20 issues a chirp-K signal and a chirp-J signal alternatively (an alternative sequence); and thereby, the multi-function printer 30 and the user PC 20 recognize that they can communicate with each other through a USB connection in the high-speed USB mode. In addition, if the multi-function printer 30 does not issue the chirp-K signal during execution of the USB bus reset signal, the connection between the user PC 20 and the multi-function printer 30 is performed through a USB connection in the full-speed USB mode. Further, the CPU 32 determines whether any one of the above-described conditions for movement to a sleep status is satisfied, or not (step S250), and if it is determined that any one of the above-described conditions for movement to a sleep status is not satisfied, the CPU 32 causes the process flow to return to step S200; in contrast, if it is determined that any one of the above-described conditions for movement to a sleep status is satisfied, the CPU 32 waits for receipt of a request from the user PC 20 for acquisition of status information (step S255), and upon receipt of the request for acquisition of state information, the CPU 32 notifies the user PC 20 of the status, in which an operation mode of the multi-function printer 30 is moving to a sleep mode (step S260). When any one of the above-described conditions for movement to a sleep mode is satisfied, the operation status of the multi-function printer 30 moves to the sleep status, and as a result, the multi-function printer 30 is in an electric power saving status. At this time, upon receipt of the notification notifying the movement thereof to a sleep status, the user PC 20 causes the USB connection to be in the suspend status, thus, the USB bus is in the full-speed USB mode under the idle status, so that electric power consumption is suppressed to a minimum amount. Subsequently, once any one of conditions for release from a sleep status is satisfied (step S270), the CPU 32 causes the USB bus status to change from the idle status and remotely wakes up the host (the user PC 20) by issuing a resume signal, thereby, causes the USB connection status to change from the suspend status to the resume status (step S280), and then, causes the process flow to return to step S200. In addition, in this embodiment, resumption to the resume status is performed through a USB connection in the full-speed USB mode, and as described above, in the case where a current connection mode is the full-speed USB mode, and further, a command from the user PC 20 is related to a request for execution of a printing job or a scanning job, the full-speed USB mode is switched to the high-speed USB mode.

Here, correspondence relations between configuration components of this embodiment and those of the invention are made obvious. The USB controller 36 of this embodiment corresponds to a communication section of the invention. The main controller 31, which is configured to execute printer-side processing shown in FIG. 3, corresponds to a connection section of the invention.

The above-described multi-function printer 30 according to this embodiment, which supports the high-speed USB mode, is configured to, when any one of conditions for movement to a sleep status has been satisfied, request the user PC 20 to issue the command “SetPortFeature (PORT_SUSPEND) to the USB hub 27, thereby, cause the USB connection to be in the suspend condition, that is, cause the USB bus to be in the full-speed USB mode under the idle condition, and thus, enables suppression of electric power consumption. Furthermore, while communication through a USB connection in the full-speed USB mode is being performed with the user PC 20, upon receipt of a request from the user PC 20 for execution of a printing job or a scanning job, for which high-speed data transmission and reception is necessary, the multi-function printer 30 disconnects the USB connection in the full-speed USB mode, and performs a reconnection to the user PC 20 through a USB connection in the high-speed USB mode, so that it is possible to realize reduction of electric power consumption, and concurrently therewith, high-speed data transmission and reception.

The multi-function printer 30 according to this embodiment is configured to, when any one of conditions for movement to a sleep mode has been satisfied, notify the user PC 20 of the movement to a sleep status in order to cause the user PC 20 to issue the command “SetPortFeature (PORT_SUSPEND), and thereby, cause the USB connection to be in the suspend status (i.e., cause the USB bus to be in the full-speed USB mode under the idle condition); however, without causing the USB connection to be in the suspend status, merely switching from the high-speed USB mode to the full-speed USB mode may be performed.

The multi-function printer 30 according to this embodiment is configured to, while communication with the user PC 20 is being performed through a USB connection in the full-speed USB mode, when a request for acquisition of status information has been received from the user PC 20, maintain the full-speed USB mode as it is, and when a request for execution of a printing job or a scanning job has been received from the user PC 20, perform switching from the full-speed USB mode to the high-speed USB mode; however, processing is not limited to such processing, in which switching between the full-speed USB mode and the high-speed USB mode is performed in accordance with a kind of communication data, but may be performed so that an amount of data transmitted and received through communication is directly monitored, and if the amount of data transmitted and received does not exceed a threshold value, the full-speed USB mode is maintained as it is; in contrast, if the amount of data transmitted and received exceeds the threshold value, switching from the full-speed USB mode to the high-speed USB mode is performed.

In this embodiment, the multi-function printer 30 including the printer unit 40 and the scanner unit 45 has been described as an application example of the invention, but the invention may be applied to a printer including only a printer unit, or a scanner including only a scanner unit. Moreover, the invention may be applied to any other apparatuses insofar as the any other apparatuses are USB device apparatuses each being capable of performing communication with a USB host apparatus through a USB connection supporting the high-speed USB mode.

In addition, the invention is not limited to the above-described embodiments, but, needless to say, the invention can be applied to various embodiments insofar as the embodiments belong to the technical scope of the invention.

The entire disclosure of Japanese Patent Application Nos. 2009-294242, filed Dec. 25, 2009 are expressly incorporated by reference herein.

What is claimed is:

1. A USB device apparatus, which is capable of performing communication with a USB host apparatus through a USB connection supporting a high-speed USB mode, the USB device apparatus comprising:
a communication section configured to be capable of performing communication with the USB host apparatus; and
a connection section configured to, while the USB device apparatus is being connected to the USB host apparatus by the communication section through a USB connection in the high-speed USB mode, when a predetermined condition for movement to a sleep status is satisfied, perform switching of a connection mode of the USB connection to the USB apparatus from the high-speed USB mode to a full-speed USB mode.

2. The USB device apparatus according to claim 1, wherein the connection section is configured to, while the USB device apparatus is being connected to the USB host apparatus through a USB connection in the full-speed USB mode, when an amount of communication data exceeds a predetermined amount, disconnect the USB connection in the full-speed USB mode, and further, reconnect the USB device apparatus to the USB host apparatus through the USB connection in the high-speed USB mode.

3. The USB device apparatus according to claim 2, wherein the connection section is configured to, while the USB device apparatus is being connected to the USB host apparatus through a USB connection in the full-speed USB mode, when communication relating to status information is performed with the USB host apparatus, maintain the full-speed USB mode as it is, and when a request for execution of a job has been received from the USB host apparatus, disconnect the USB connection in the full-speed USB mode, and further, reconnect the USB device apparatus to the USB host apparatus through the USB connection in the high-speed USB mode.

4. The USB device apparatus according to claim 3, wherein the USB device apparatus functions as a printing apparatus that is configured to, when, as the request from the USB host apparatus for execution of a job, receive a request for execution of a printing job, and execute the printing job.

5. The USB device apparatus according to claim 3, wherein the USB device apparatus functions as a scanner apparatus that is configured to, when, as the request from the USB host apparatus for execution of a job, receive a request for execution of a scanning job, and execute the scanning job.

6. A USB device apparatus, which is capable of performing communication with a USB host apparatus through a USB connection supporting a high-speed USB mode, the USB device apparatus comprising:
a communication section configured to be capable of performing communication with the USB host apparatus; and
a connection section configured to, while the USB device apparatus is being connected to the USB host apparatus by the communication section through a USB connection in the high-speed USB mode or in a full-speed USB mode, when a predetermined condition for movement to a sleep status is satisfied, perform switching of a connection status of the USB connection to the USB host apparatus to a suspend status.

7. The USB device apparatus according to claim 6, wherein the connection section is configured to, while the USB device apparatus is being connected to the USB host apparatus through a USB connection in the suspend status, when communication data has been generated, resume from the suspend status, further, when an amount of the communication data exceeds a predetermined amount, reconnect the USB device apparatus to the USB host apparatus through the USB connection in the high-speed USB mode, and when the amount of the communication data does not exceed the predetermined amount, reconnect the USB device apparatus to the USB host apparatus through the USB connection in the full-speed USB mode.

8. The USB device apparatus according to claim 6, wherein the connection section is configured to, while the USB device apparatus is being connected to the USB host apparatus through a USB connection in the suspend status, when a communication command has been received from the USB host apparatus, resume from the suspend status, and reconnect the USB device apparatus to the USB host apparatus through the USB connection in the high-speed USB mode or the full-speed USB mode, whichever is determined in accordance with a content of the communication command.

9. The USB device apparatus according to claim 8, wherein the communication command is a communication command that specifies the high-speed USB mode or the full-speed USB mode, with which the reconnection is to be performed by the connection section.

10. The USB device apparatus according to claim 8, wherein the communication command is a communication command that specifies an amount of data for communication with the USB host apparatus, which is to be performed immediately subsequent to receipt of the communication command.

11. The USB device apparatus according to claim 8, wherein the communication command is a communication command that specifies a kind of data for communication with the USB host apparatus, which is to be performed immediately subsequent to receipt of the communication command.

12. The USB device apparatus according to claim 6, wherein the connection section is configured to, while the USB device apparatus is being connected to the USB host apparatus through a USB connection in the suspend status, when communication data has been generated, resume from the suspend status, and reconnect the USB device apparatus to the USB host apparatus through the USB connection in the high-speed USB mode or the full-speed USB mode, whichever is determined in accordance with a kind of the communication data.

13. The USB device apparatus according to claim 1, wherein the predetermined condition is a condition that is satisfied when a status in which no manual operation is performed has been continued for more than or equal to a predetermined period of time.
